(19) United States
(12) Patent Application Publication
(10) Pub. No.: US 2022/0102024 A1
(43) Pub. Date: Mar. 31, 2022

(54) INSULATED WIRE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Kenichiro ARAKI, Mie (JP)

(21) Appl. No.: 17/423,427

(22) PCT Filed: Jan. 17, 2020
(86) PCT No.: PCT/JP2020/001455

§ 371 Date: Jul. 15, 2021

(30) Foreign Application Priority Data
Jan. 30, 2019 (JP) 2019-014300

(51) Int. Cl. H01B 7/22; H01B 1/12

(52) U.S. Cl. CPC H01B 7/228; H01B 1/124

(57) ABSTRACT

Provided is an insulation wire with which both protection from impacts and space-saving can be achieved. An insulation wire 1 comprises: a core wire 10 including a conductor 11 and an insulation coating 12 that is made of an insulation material and that coats the outer periphery of the conductor; and a protection layer 20 configured by a wire material of a higher strength than that of the insulation material forming the insulation coating 12, the wire material surrounding the outer periphery of the core wire 10 by intersecting the axial direction A of the core wire 10. The wire material that constitutes the protection layer 20 bites into the surface of the insulation coating 12. Alternatively, the protection layer 20 is adhered to the surface of the insulation coating 12 with an adhesive force of 0.014 N/mm² or more.

### TECHNICAL FIELD

The present disclosure relates to an insulated wire.

### BACKGROUND

In using an insulated wire, in which a conductor is covered with an insulation coating, in a place subjected to an external impact such as the inside of an automotive vehicle, it is important to prevent that the insulated wire is damaged to impair the protection performance and insulation performance of the insulation coating for the conductor. If the insulation coating is broken by an impact to expose the conductor, there is also a possibility of leading to a short circuit or wire breakage.

It can be cited as a method for preventing the damage of an insulation coating by an impact to form the insulation coating using a material having a high impact resistance. The use of such an insulation coating is, for example, disclosed in Patent Document 1. The use of an exterior member arranged outside an insulated wire and formed of a material or a structure having impact resistance or shock absorbability can be cited as another method. The use of such an exterior member is, for example, disclosed in Patent Document 2.

### PRIOR ART DOCUMENT

### Patent Document

Patent Document 1: JP 2008-159359 A

Patent Document 2: JP 2017-175801 A

### SUMMARY OF THE INVENTION

### Problems to be Solved

In the case of enhancing the impact resistance of the material of the insulation coating constituting the insulated wire as in an example described in Patent Document 1, it is desired to use a material having a high impact resistance while satisfying various characteristics such as insulation and flexibility required for the insulation coating of the wire. However, it is difficult in many cases to enhance impact resistance while ensuring those various characteristics.

On the other hand, if the exterior member having high impact resistance and shock absorbability is arranged outside the insulated wire, a large space is necessary to route a wiring harness due to the presence of the exterior member. Particularly, if an attempt is made to enhance the shock absorbability of the exterior member, the exterior member tends to occupy a large space such as a bellows structure disclosed in Patent Document 2. In recent years, the space saving of a wiring harness has been required in automotive vehicles and the like and, in terms of space saving, it is more preferable not to use an exterior member occupying a large space as a countermeasure against impacts.

In terms of protecting the insulated wire from impact application while ensuring the space saving of the insulated wire itself or the wiring harness as a whole, it is desired to protect the insulated wire from impact application by a measure different from the study of the constituent material of the insulation coating and the study of the material and structure of the exterior member.

Accordingly, it is aimed to provide an insulated wire capable of combining protection from impacts and space saving.

### Means to Solve the Problem

A first insulated wire according to the present disclosure is provided with a core wire including a conductor and an insulation coating made of an insulating material for covering an outer periphery of the conductor, and a protection layer formed by a wire material having a higher strength than the insulating material constituting the insulation coating and surrounding an outer periphery of the core wire to intersect an axial direction of the core wire, the wire material constituting the protection layer biting in a surface of the insulation coating.

A second insulated wire according to the present disclosure is provided with a core wire including a conductor and an insulation coating made of an insulating material for covering an outer periphery of the conductor, and a protection layer formed by a wire material having a higher strength than the insulating material constituting the insulation coating and surrounding an outer periphery of the core wire to intersect an axial direction of the core wire, the protection layer being held in close contact with a surface of the insulation coating with an adhesion force of 0.014 N/mm² or more.

### Effect of the Invention

The insulated wire according to the present disclosure can combine protection from impacts and space saving.

### BRIEF DESCRIPTION OF THE DRAWINGS

FIGS. 1A and 1B show an insulated wire according to a first embodiment of the present disclosure, wherein FIG. 1A is a side view and FIG. 1B is a section.

FIGS. 2A and 2B show a protection layer of the insulated wire, wherein FIG. 2A is a plan view showing a braided structure of a braided body and FIG. 2B is a section showing an interface state between the protection layer and an insulation coating.

FIG. 3 is a graph showing a relationship of an adhesion force of the protection layer to a core wire and a wire strength.

FIG. 4 shows a photographed image of a surface of the insulation coating after the protection layer was removed.

### DETAILED DESCRIPTION TO EXECUTE THE INVENTION

### Description of Embodiments of Present Disclosure

First, embodiments of the present disclosure are listed and described.

A first insulated wire according to the present disclosure is provided with a core wire including a conductor and an insulation coating made of an insulating material for covering an outer periphery of the conductor, and a protection layer formed by a wire material having a higher strength than the insulating material constituting the insulation coating and surrounding an outer periphery of the core wire to intersect an axial direction of the core wire, the wire material constituting the protection layer biting in a surface of the insulation coating.

A second insulated wire according to the present disclosure is provided with a core wire including a conductor and an insulation coating made of an insulating material for covering an outer periphery of the conductor, and a protection layer formed by a wire material having a higher strength than the insulating material constituting the insulation coating and surrounding an outer periphery of the core wire to intersect an axial direction of the core wire, the protection layer being held in close contact with a surface of the insulation coating with an adhesion force of 0.014 N/mm² or more.

The first and second insulated wires include the protection layer, which is constituted by the wire material having a higher strength than the insulating material constituting the insulation coating of the core wire, on the outer periphery of the core wire. Due to the strength of the wire material constituting the protection layer, an impact is unlikely to be transferred to the core wire when the impact is applied to the insulated wire from outside. Particularly, the protection layer can give a high impact resistance to the core wire since the wire material constituting the protection layer is biting in the surface of the insulation coating in the first insulated wire, and since the protection layer is in close contact with the surface of the insulation coating with an adhesion force of 0.014 N/mm² or more in the second insulated wire. Further, the wire material is unlikely to move along the axial direction of the core wire and, in either insulated wire, a situation where the wire material is concentrated in a specific place along the axial direction of the core wire due to impact application or the like is unlikely to occur. The slack of the wire material with respect to the core wire is also unlikely to occur. Thus, the protection layer can exhibit a high impact protection performance with high uniformity. Further, since the protection layer is held in close contact with the outer periphery of the core wire, an outer diameter of the insulated wire is unlikely to increase even if the protection layer is disposed. In this way, a high impact resistance and space saving can be combined.

Here, in the first insulated wire, the protection layer may be held in close contact with the surface of the insulation coating with an adhesion force of 0.014 N/mm² or more. Then, the protection layer is particularly strongly held in close contact with the insulation coating by both effects brought about by the biting of the wire material into the insulation coating and a high adhesion force. As a result, a particularly high impact resistance is obtained in the insulated wire.

Further, in the first and second insulated wires, the wire materials constituting the protection layer may include at least a first group of the wire materials arranged along a first direction intersecting the axial direction of the core wire and a second group of the wire materials arranged along a second direction intersecting the axial direction of the core wire and the first direction. Then, the protection layer easily shows a high impact resistance against impacts applied from various directions on the surface of the core wire.

The protection layer may be configured as a braided body formed by braiding the wire materials. Then, the wire materials are arranged with high uniformity and along a plurality of directions in each part of the surface of the core wire. Further, the wire materials are unlikely to move on the surface of the core wire due to a stitch structure of the braided body. Thus, the protection layer shows a particularly high impact resistance against impacts applied from various directions in each part of the core wire. Further, the protection layer can be simply formed using a facility for forming a braided shield for electromagnetically shielding the insulated wire.

The wire material constituting the protection layer may have a higher melting point than the insulating material constituting the insulation coating. Then, the wire material constituting the protection layer is easily caused to bite into the surface of the insulation coating by heating an assembly of the core wire and the protection layer to a temperature equal or higher than or close to the melting point of the insulating material after the protection layer is arranged on the surface of the core wire. Further, the protection layer is easily held in close contact with the surface of the insulation coating with a high adhesion force. As a result of those, the insulated wire in which the protection layer exhibits a high impact resistance for the core wire can be simply formed.

The wire material constituting the protection layer may be an organic fiber. Then, the protection layer can be formed to be lightweight. Further, since a high affinity to the insulation coating of the core wire similarly mainly containing an organic polymer is exhibited, the protection layer is easily held in close contact with the surface of the insulation coating by heating or the like.

The wire material constituting the protection layer may be an aramid fiber. The aramid fiber is a material having a high strength among various organic fibers, and can form the protection layer which is lightweight and exhibits a high impact resistant effect.

The insulating material constituting the insulation coating may contain a cross-linked polymer. Then, the physical properties and shape of the insulation coating are easily maintained due to a crosslink structure even if heating is performed at a temperature equal to or more than or close to the melting point of the insulating material constituting the insulation coating to cause the protection layer to bite into the insulation coating or hold the protection layer in close contact with the insulation coating with the protection layer arranged on the outer periphery of the core wire. Thus, the protection layer can be caused to bite into the insulation coating or held in close contact with the insulation coating with functions of the insulation coating maintained, whereby a high impact resistance given by the protection layer can be utilized. The physical properties such as the melting point are easily controlled by adjusting a crosslink density.

The insulated wire may include a sheath made of an insulator for covering an outer periphery of the protection layer. Then, the sheath physically protects the protection layer and functions to suppress a position shift of the wire material constituting the protection layer. Thus, a state where a high impact resistance is exhibited by the protection layer can be maintained over a long period of time. The handleability of the insulated wire is also enhanced.

### Details of Embodiments of Present Disclosure

Hereinafter, insulated wires according to embodiments of the present disclosure are described in detail using the drawings.

### [1] Insulated Wire According to First Embodiment

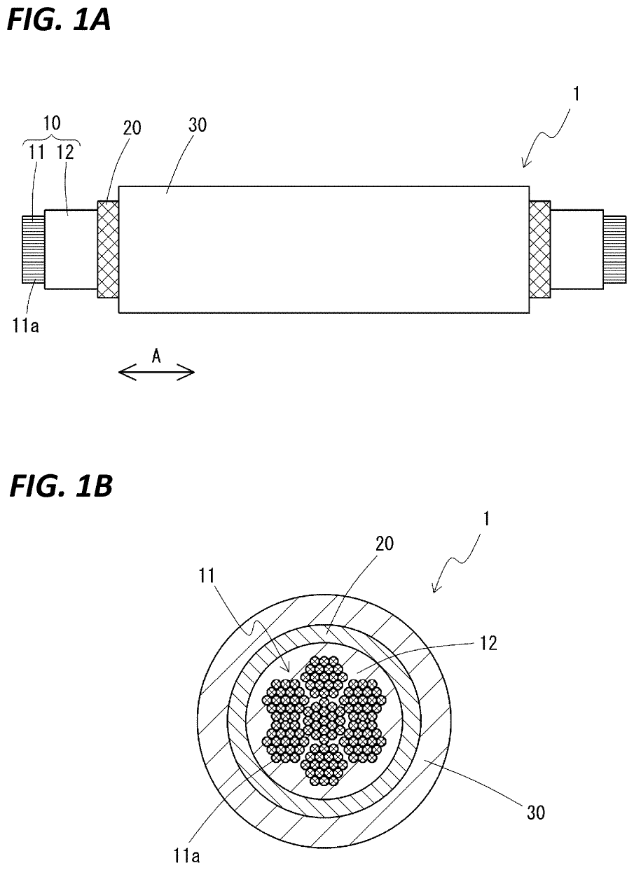

First, an insulated wire 1 according to a first embodiment of the present disclosure is described. FIGS. 1A and 1B show the configuration of the insulated wire 1. The insulated wire 1 includes a core wire 10, a protection layer 20 arranged on the outer periphery of the core wire 10 and a sheath 30 arranged on the outer periphery of the protection layer 20. As described in detail later, the protection layer 20 is configured as an aggregate of wire materials 21 and the wire materials 21 constituting the protection layer 20 bite into the insulation coating 12 of the core wire 10 to be held in close contact with the insulation coating 12.

The core wire 10 includes a conductor 11 made of a long conductive material and an insulation coating 12 made of an insulating material for covering the outer periphery of the conductor 11. A conventional general insulated wire including a conductor and an insulation coating can also be utilized as the core wire 10.

The structure of the conductor 11 constituting the core wire 10 is not particularly limited, but the conductor 11 is preferably configured as a stranded wire formed by twisting a plurality of strands 11a in terms of flexibility. In a form shown in FIG. 1B, a parent-child twist structure is adopted in which a plurality of stranded wires each formed by twisting a plurality of strands 11a are aggregated and further twisted. A conductor cross-sectional area of the conductor 11 and a strand diameter in the case of forming the conductor 11 from a stranded wire are not particularly limited.

The constituent material of the conductor 11 is also not particularly limited and various conductive materials can be used. However, copper or copper alloy is generally used as conductors of insulated wires. Besides copper, a metal such as aluminum, magnesium or iron or an alloy mainly containing one of those metal elements may be used. If the conductor 11 is configured as a stranded wire, the strands 11a all made of the same metal material or the strands 11a made of a plurality of metal materials may be twisted. Further, the conductor 11 may appropriately include a wire material other than the strands 11a made of conductive material(s) such as an organic fiber as a reinforcing wire.

An insulating polymer material or the one added with various additives can be used as the insulating material constituting the insulation coating 12 of the core wire 10. Examples of the polymer material include polyolefins such as polyethylene and polypropylene, polyvinyl chloride (PVC), thermoplastic elastomer and rubber. The polymer material may or may not be cross-linked. However, in terms of easily maintaining the shape and material physical properties of the insulation coating 12 at the time of heating for adhesion to the protection layer 20, it is preferable to use cross-linked polymers such as cross-linked polypropylene.

Further, the polymer material constituting the insulation coating 12 preferably has a lower melting point (or softening temperature; the same applies hereinafter) than the wire materials 21 constituting the protection layer 20 to be described later in terms of strengthening biting into and adhesion of the protection layer 20 and in terms of simplifying a process for causing biting and adhesion. If the polymer material is a cross-linked polymer, the melting point can be controlled by a crosslink density.

A thickness of the insulation coating 12 is not particularly limited but, for biting and adhesion of the protection layer 20, is preferably sufficient to maintain a structure and functions as the insulation coating even if the insulation coating 12 is partially melted. On the other hand, impact resistance needs not be ensured by the thickness of the insulation coating 12 since the protection layer 20 is provided.

The sheath 30 functions to physically protect the protection layer 20 and assist the maintenance of an aggregate structure of the wire materials 21 in the protection layer 20 such as a braided structure by covering the outer periphery of the protection layer 20. The sheath 30 also functions to enhance the handleability of the insulated wire 1 by preventing the protection layer 20 configured as a braided body or the like from being exposed. The sheath 30 may be constituted by any insulator, but is preferably made of an insulating polymer material or that added with appropriate additive(s). Similarly to the insulation coating 12 of the core wire 10, polyolefins such as polyethylene and polypropylene, PVC, thermoplastic elastomer, rubber and the like can be cited as the polymer material constituting the sheath 30. A thickness of the sheath 30 is also not particularly limited and may be selected to be able to exhibit a sufficient protection performance for the protection layer 20 within a range that the insulation coating 1 is not excessively enlarged in diameter. Note that the sheath 30 may be omitted, such as if the protection layer 20 has a sufficiently high strength and needs not be protected or if the aggregate structure of the wire materials 21 can be firmly maintained.

Each of the insulation coating 12, the sheath 30 and the protection layer 20 constituting the insulated wire 1 may include a plurality of layers. Further, a member other than those may be arranged between the insulation coating 12 and the protection layer 20, between the protection layer 20 and the sheath 30, on an outer peripheral part of the sheath 30 and the like. An adhesive can be illustrated as such a member. The adhesive can be arranged between the insulation coating 12 and the protection layer 20 and/or between the protection layer 20 and the sheath 30 to bond the members on both sides to each other.

(Configuration of Protection Layer)

As described above, the protection layer 20 is constituted by an aggregate of the wire materials 21. The wire materials 21 constituting the protection layer 20 have a higher strength than the insulating material constituting the insulation coating 12 of the core wire 10. Here, the strength of the wire materials 21 constituting the protection layer 20 and that of the insulating material constituting the insulation coating 12 are preferably compared based on breaking strength, particularly tensile breaking strength. The tensile breaking strength can be evaluated according to JIS K 7161 for materials mainly containing an organic polymer and according to JIS Z 2241 for metal materials. Further, the strength of the wire materials 21 constituting the protection layer 20 and that of the insulating material constituting the insulation coating 12 are compared for values standardized by the cross-sectional areas of those.

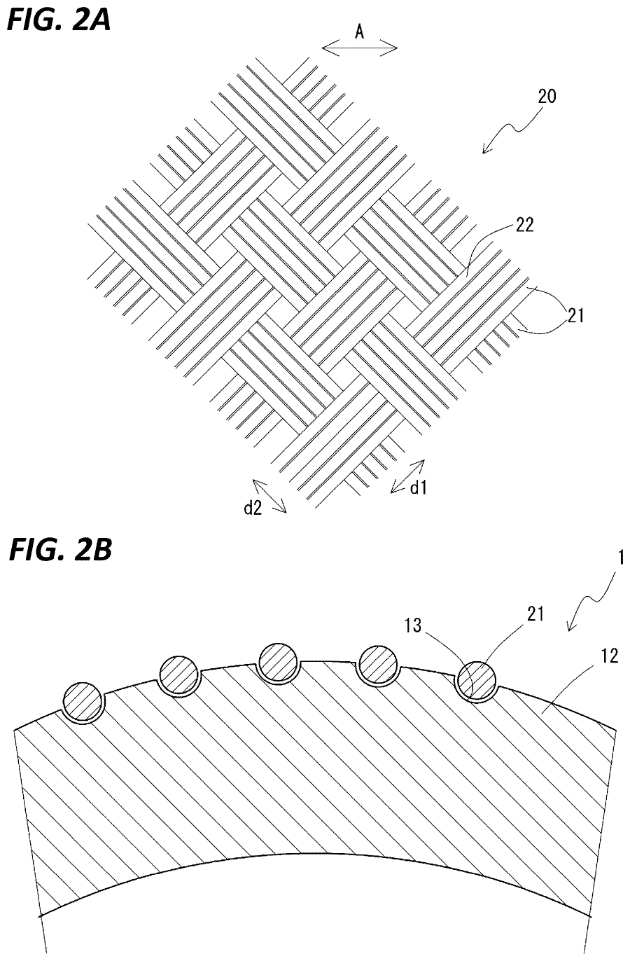

In the protection layer 20, the wire materials 21 surround the outer periphery of the core wire 10 with axes thereof extending in directions intersecting an axial direction A of the core wire 10. In this embodiment, the protection layer 20 is configured as a braided body in the form of a hollow tube by braiding the plurality of wire materials 21. As shown in FIG. 2A, the wire materials 21 constituting the braided body are braided with longitudinal directions thereof aligned with two directions d1, d2 intersecting the axial direction A and intersecting each other.

As shown in FIG. 2B, the wire materials 21 constituting the protection layer 20 are biting in a surface of the insulation coating 12. That is, depressed parts 13 having the same shape and dimensions as or slightly larger than the shape and dimensions of at least partial regions of the wire materials 21 along circumferences are formed in the surface of the insulation coating 12, and at least the partial regions of the wire materials 21 are accommodated along the circumferences in the depressed parts 13. Inner wall surfaces of the depressed parts 13 are in close contact with the outer peripheral surfaces of the wire materials 21.

In the insulated wire 1 according to this embodiment, the protection layer 20 is formed which is held in close contact with the outer periphery of the core wire 10 and formed from the wire materials 21 having a higher strength than the insulating material constituting the insulation coating 12 of the core wire 10. By surrounding the core wire 10 with the protection layer 20 made of the high strength material, the protection layer 20 exhibits impact resistance for the core wire 10 and the damage and fracture of the insulation coating 12 of the core wire 10 due to impact application can be suppressed when an external impact is applied to the insulated wire 1. Particularly, since the wire materials 21 are arranged along the directions d1, d2 intersecting the axial direction A of the core wire 10 and surround the outer periphery of the core wire 10 in the protection layer 20, impact resistance can be exhibited against impacts applied from various directions along the circumference of the core wire 10.

If the insulation coating 12 is damaged or fractured by impact application, there is a possibility that the insulation coating 12 cannot maintain inherent functions such as protection and insulation for the conductor 11. There is also a possibility that even the conductor 11 in the insulation coating 12 is affected by the damage or fracture of the insulation coating 12. However, in the insulation coating 1 according to this embodiment, since the protection layer 20 has a high impact resistance, the occurrence of those phenomena in association with impact application is suppressed and the insulated wire 1 can be used while the inherent functions are maintained even in such an environment in which an impact is possibly applied.

Further, since the wire materials 21 constituting the protection layer 20 are biting in the surface of the insulation coating 12 of the core wire 10, the protection layer 20 is held in close contact with the core wire 10 and impact resistance exhibited by the protection layer 20 for the core wire 10 is enhanced. Further, position shifts of the wire materials 21 along the axial direction A of the core wire 10 and the radially outward loosening of the core wire 10 are unlikely to occur with a predetermined arrangement such as the braided structure kept due to the biting of the wire materials 21. Thus, even if the insulated wire 1 is subjected to the application of vibration or an impact, a situation where a degree of adhesion of the protection layer 20 to the core wire 10 is reduced or a situation where the wire materials 21 are concentrated on a specific part in the axial direction A of the core wire 10 to cause unevenness in the distribution density of the wire materials 21 is unlikely to occur. As a result, the protection layer 20 can exhibit an effect of giving impact resistance with high uniformity along the axial direction A of the core wire 10 and a state where impact resistance is exhibited with high uniformity in that way can be maintained over a long period of time.

As just described, in the insulated wire 1 according to this embodiment, the core wire 10 can be protected from impact application and the damage and fracture of the insulation coating 12 caused by impact application and, further, an influence on the conductor 11 can be suppressed by the presence of the protection layer 20. Since impact resistance can be ensured by the protection layer 20 arranged on the outer periphery of the core wire 10, the insulation coating 12 constituting the core wire 10 needs not singly have strength and impact resistance capable of sufficiently protecting the conductor 11 from impact application. Thus, impact resistance can be enhanced by using one of various insulated wires such as conventional general insulated wires as the core wire 10 and providing the protection layer 20 on the outer periphery of the insulated wire. The insulated wire 1 according to this embodiment can be suitably used in a place subjected to impact application such as an automotive vehicle by having a high impact resistance.

Further, since the protection layer 20 is held in close contact with the surface of the core wire 10 by the wire materials 21 biting into the surface of the insulation coating 12, an outer diameter of the entire insulated wire 1 is unlikely to considerably increase. Thus, if the insulated wire 1 is used in a wiring harness, a bulky exterior member having impact resistance and shock absorbability need not be arranged outside and the space saving of the insulated wire 1 and the wiring harness can be ensured. A high impact resistance can be obtained also when a material having a higher strength than the insulating material constituting the insulation coating 12 is molded into a surface shape such as a sheet shape, tape shape or tube shape and arranged as a protection layer on the outer periphery of the core wire 10, similarly to the protection layer 20 according to this embodiment. However, in these cases, the outer diameter of the entire insulated wire including the protection layer increases and the mass thereof also tends to increase. On the other hand, by forming the protection layer 20 from the wire materials 21 and causing the wire materials 21 to bite into the insulation coating 12 as described above, the outer diameter and mass of the entire insulated wire 1 can be suppressed to be smaller than in the case where the protection layer is formed using a member having a surface shape. The flexibility of the insulated wire 1 is also easily ensured. By using the wire materials 20, a total amount of the high strength material constituting the protection layer 20 is less than in the case of using the member having the surface shape. However, a high impact resistance can be ensured with a small amount of the material by causing the wire materials 21 to bite into the surface of the insulation coating 12 and suppressing the position shifts and slack of the wire materials 12 as described above. In recent years, space saving has been required in wiring in automotive vehicles. The insulated wire 1 according to this embodiment combining high space saving and impact resistance can be suitably used in automotive vehicles.

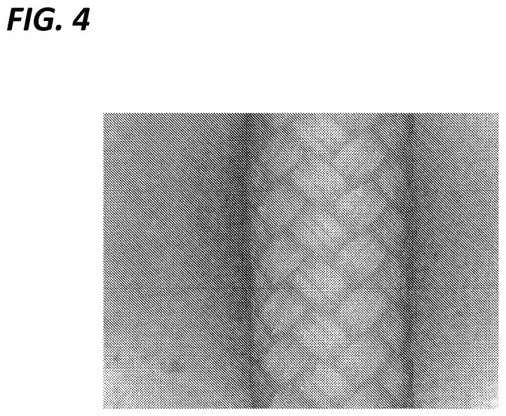

In the insulated wire 1, the biting of the wire materials 21 constituting the protection layer 20 in the surface of the insulation coating 12 can be confirmed by observing a cross-section of the insulated wire 1 and detecting the formation of the depressed parts 13 and the fitting of the wire materials 21 in the depressed parts 13 as in FIG. 2B or can be confirmed by, after the protection layer 20 is removed from the outer periphery of the core wire 10, observing the surface of the insulation coating 12 and detecting a remaining groove-like structure derived from the depressed portions 13 (see FIG. 4).

The wire materials 21 constituting the protection layer 20 may be any wires as long as having a higher strength than the insulating material constituting the insulation coating 12 of the core wire 10. Metal materials, inorganic fibers and organic fibers can be illustrated as the material constituting the wire materials 21.

Thin wires made of copper, aluminum, iron or alloys of those metals can be cited as the wire materials 21 made of the metal material. Metal thin wires similar to those used in a braided shield body for electromagnetically shielding an insulated wire can be suitably utilized. Metal materials are inferior in lightness and inexpensiveness than organic fibers and inorganic fibers, but have a very high material strength and can exhibit a particularly high impact resistance. Examples of the inorganic fibers include glass fibers and carbon fibers. Examples of the organic fibers include tensile strength fibers such as aramid fibers. The tensile strength fibers such as aramid fibers can combine a high strength and lightness and can be most suitably utilized as the wire materials 21 constituting the protection layer 20. Further, by being made of an organic polymer material similarly to the insulation coating 12 of the core wire 10, the wire materials 21 show a high adhesion to the insulation coating 12, wherefore a high impact resistance can be given by adhesion to the insulation coating 12.

Further, in terms of simply forming the state where the wire materials 21 are biting in the surface of the insulation coating 12, the wire materials 21 preferably have a higher melting point than the insulating material constituting the insulation coating 12 and are not so denatured as to affect the provision of impact resistance at the melting point of the insulating material constituting the insulation coating 12. Any of the metal materials, inorganic fibers and tensile strength fibers listed above satisfy such properties in many cases in comparison to polymer materials often used as insulation coatings of insulated wires. Tensile strength fibers represented by aramid fibers can be suitably utilized as the wire materials 21 also because of a high melting point (or having no melting point) and a high heat resistance. Note that having a higher melting point than the insulating material constituting the insulation coating 12 indicates a state where the material is not melted even if being heated at a temperature higher than the melting point of the insulation coating 12 and includes a case where the material has no melting point, i.e. is not melted before thermal denaturation.

The outer diameters of the wire materials 21 constituting the protection layer 20 are not particularly limited. A thickness of the protection layer 20 as a whole is also not particularly limited.

The arrangement of the wire materials 21 in the protection layer 20 may be any arrangement as long as the longitudinal directions of the wire materials 21 extend in directions intersecting the axial direction A of the core wire 10 and the wire materials 21 surround the outer periphery of the core wire 10 over the entire circumference. Besides the braided structure described above, a structure in which the wire materials 21 are spirally wound with the axial direction A of the core wire 10 as a center can also be illustrated. The protection layer 20 preferably includes a first group of the wire materials 21 extending along the first direction d1 and a second group of the wire materials 21 extending along the second direction d2. Here, the first and second directions d1, d2 both intersect the axial direction A of the core wire 10 and intersect each other. By configuring the protection layer 20 by arranging the wire materials 21 in a plurality of different directions in that way, the core wire 10 is easily protected from impact application from many directions. Besides the above braided structure, the spiral winding of the wire materials 21 in a plurality of different directions on the outer periphery of the core wire 10 can be illustrated as the arrangement of the wire materials 21 in a plurality of different directions.

By configuring the protection layer 20 as the braided body formed by braiding the wire materials 21, a particularly high impact resistance can be obtained as compared to the case where the wire materials 21 are wound, e.g. spirally wound, on the outer periphery of the core wire 10. This is because the wire materials 21 extending in the both directions d1, d2 are fixed, and position shifts in the axial direction A of the core wire 10 and the like and the unevenness in distribution and the slack of the wire materials 21 can be effectively suppressed by stitches 22 where the wire materials 21 extending along the first direction d1 and the wire materials 21 extending along the second direction d2 intersect. Further, if the wire materials 21 arranged along the first and second directions d1, d2 are braided not in a state where the wire materials 21 are independent one by one, but in a state where a plurality of wire materials 21 are bundled and twisted, the unevenness in distribution and the slack of the wire materials 21 can be particularly effectively suppressed by both effects brought about by the twisting of the bundled wire materials 21 and the fixing of the bundles by the stitches 22.

The density of the wire materials 21 constituting the protection layer 20 is preferably 67% or more in terms of exhibiting a high impact resistance. On the other hand, this density is preferably 80% or less in terms of reducing the weight of the protection layer 20. The density of the wire materials 21 is a ratio of an area occupied by the wire materials 21 in the surface of the protection layer 20 and corresponds to a braid density if the protection layer 20 is configured as a braided body.

As described above, in the insulated wire 1 according to this embodiment, the wire materials 21 are held in close contact with the outer periphery of the core wire 10, position shifts and slack are unlikely to occur and a high impact resistance is exhibited by the protection layer 20 since the wire materials 21 constituting the protection layer 20 are biting in the surface of the insulation coating 12 of the core wire 10. Here, in the state where the wire materials 21 are biting in the insulation coating 12, a value of an adhesion force of the protection layer 20 to the insulation coating 12 measured by a pull-out test as described in Examples later may be 50 N or more, more preferably 80 N or more. If the adhesion force is standardized by a contact area between the protection layer 20 and the insulation coating 12, this value may be 0.014 N/mm² or more, more preferably 0.022 N/mm² or more.

If the protection layer 20 shows such a high adhesion force to the insulation coating 12, impact resistance exhibited by the protection layer 20 can be effectively enhanced. Further, the position shifts and slack of the wire materials 21 are firmly suppressed, and a state where uniformity is high along the axial direction A of the core wire 10 and impact resistance is enhanced is particularly easily maintained. An improvement in the adhesion force of the protection layer 20 to the insulation coating 12 can be achieved by fusion associated with melting or softening and solidification of the insulation coating 12. Alternatively, adhesion may be assisted by interposing an adhesive between the surface of the insulation coating 12 having the depressed parts 13 and the protection layer 20.

(Insulated Wire Manufacturing Method)

Next, a manufacturing method of the insulated wire 1 according to this embodiment is briefly described.

First, the core wire 10 is prepared. The core wire 10 can be manufactured by forming the insulation coating 12 on the surface of the conductor 11 formed, such as by twisting the strands 11a, by extrusion-molding a polymer composition or the like. The insulation coating 12 may be cross-linked as appropriate after molding.

Subsequently, the protection layer 20 is arranged on the outer periphery of the core wire 10. The protection layer 20 may be arranged by a method corresponding to the configuration of the protection layer 20. If the spiral wire materials 21 constitute the protection layer 20, the wire materials 21 may be wound on the outer periphery of the core wire 10. If the braided body constitutes the protection layer 20, the wire materials 21 may be braided into a tubular shape on the outer periphery of the core wire 10. Conventionally, a tubular braided shield has been often used as a shield body of an insulated wire. Using a facility for forming such a braided shield, the protection layer 20 in the form of a braided body can be simply formed from the wire materials 21. In either case, the wire materials 21 are preferably brought into contact with the insulation coating 12 while forming as little clearance as possible between the surface of the core wire 10 and the protection layer 20. Further, if a layer of an adhesive is arranged between the protection layer 20 and the insulation coating 12, the adhesive may be applied or extruded to the surface of the core wire 10 before the protection layer 20 is arranged.

In the protection layer 20 arranged on the outer periphery of the core wire 10, the wire materials 21 need to bite into the surface of the insulation coating 12 of the core wire 10. The wire materials 21 can bite into the insulation coating 12, such as by forming fine grooves, which will become the depressed part 13, in the surface of the insulation coating before the wire materials 21 are arranged or by tightly spirally winding the wire materials 21 or braiding the wire materials 21 into the braided structure on the core wire 10 so that the wire materials 21 dynamically bite into the insulation coating 12, but firm biting can be simply achieved by utilizing the softening or melting of the insulation coating 12 by heating as described next.

That is, the protection layer 20 is arranged on the outer periphery of the core wire 10 and an assembly of the core wire 10 and the protection layer 20 is heated with the wire materials 21 held in contact with the insulation coating 12. At this time, heating is preferably performed until the insulating material constituting the insulation coating 12 is softened or melted, particularly until the surface of the insulation coating 12 is partially melted. As a heating temperature increases and as a heating time becomes longer, the softening and melting of the insulation coating 12 progress up to the inside of the core wire 10. The heating temperature and the heating time may be set to achieve a desired state. If the surface of the insulation coating 12 is softened or melted, the wire materials 21 in contact with the insulation coating 12 sink from the surface of the insulation coating 12 so that the surfaces thereof are at least partially surrounded by the insulating material constituting the insulation coating 12 and embraced by the insulating material. If the assembly of the core wire 10 and the protection layer 20 is cooled in this state, the insulating material is solidified while embracing the wire materials 21. As a result, as shown in FIG. 2B, the depressed parts 13 matching the shape of the wire materials 21 are formed in the surface of the insulation coating 12 and the wire materials 21 are fit in the depressed parts 13 and held in close contact with the inner walls of the depressed parts 13. Particularly, if the surface of the insulation coating 12 is not only softened, but also melted, the wire materials 21 and the inner wall surfaces of the depressed parts 13 are easily firmly bonded by fusion.

In causing the wire materials 21 to bite into the surface of the insulation coating 12 by heating in this way, the assembly of the core wire 10 and the protection layer 20 is preferably heated to the melting point of the insulation coating 12 or higher in terms of enhancing an adhesion force between the both. In this case, if the insulating material constituting the insulation coating 12 has a higher melting point than the material constituting the wire materials 21, the wire materials 21 can be caused to deeply bite into the insulation coating 12 and obtain a high adhesion force by way of the melting of the insulating material while avoiding a reduction in strength due to the melting of the wire materials 21 by heating the assembly at a temperature equal to or higher than the melting point of the insulating material constituting the insulation coating 12 and lower than the melting point of the material constituting the wire materials 21. For example, if the insulation coating 12 is made of cross-linked polyethylene and the wire materials 21 are made of aramid fibers, heating is preferably performed at a temperature higher than 70° C. However, in heating, the heating temperature and the heating time are preferably so set that the material constituting the wire materials 21 is not denatured to affect impact resistance, besides melting, by heat. For example, if the insulation coating 12 is made of cross-linked polyethylene and the wire materials 21 are made of aramid fibers, the heating temperature is preferably set to 150° C. or lower at which the aramid fibers are not thermally denatured.

Further, heating is preferably performed within such a range that the shape and physical properties of the insulation coating 12 are not largely affected. For example, at least a region of the insulation coating 12 near the surface is melted or softened by heating to such an extent that the wire materials 21 constituting the protection layer 20 can bite thereinto, but the shape and the physical properties of the insulation coating 12 as a whole are preferably not so changed as to affect functions as the insulation coating 12 after the insulation coating 12 is cooled after being heated. Such a state can be realized also by the selection of the insulating material constituting the insulation coating 12 in addition to the selection of the heating temperature and the heating time. For example, by making the insulation coating 12 of cross-linked polymer such as cross-linked polyethylene, the softening or melting to allow the biting of the wire materials 21 can be achieved by the contribution of an uncross-linked part while maintaining the shape and physical properties of the insulation coating 12 as a whole by a cross-linked structure. The softening temperature and melting point can be controlled within a certain range by adjusting the crosslink density.

After the protection layer 20 is formed in a state where the wire materials 21 are biting in the insulation coating 12 by way of heating or the like, the sheath 30 may be formed on the surface of the protection layer 20 as appropriate. The sheath 30 can be formed, such as by extrusion-molding a polymer composition.

### [2] Insulated Wire According to Second Embodiment

Next, an insulated wire according to a second embodiment of the present disclosure is described. Here, only parts different from the configuration of the insulated wire 1 according to the first embodiment are described. The other configuration is similar to that of the insulated wire 1 according to the first embodiment.

In the insulated wire 1 according to the first embodiment, the wire materials 21 constituting the protection layer 20 are biting in the surface of the insulation coating 12 of the core wire 10. However, in the insulated wire according to the second embodiment, wire materials 21 do not necessarily bite into a surface of an insulation coating 12 of a core wire 10.

In the insulated wire according to the second embodiment, the protection layer 20 is in close contact with the surface of the insulation coating 12 of the core wire 10 with a predetermined adhesion force or more. Specifically, the adhesion force is 50 N or more as a value measured by the pull-out test as described in Examples later. If being standardized by a contact area between the protection layer 20 and the insulation coating 12, the adhesion force is 0.014 N/mm². Further, the adhesion force may be 80 N or more as a value measured by the pull-out test and may be 0.022 N/mm² as a standardized value.

By holding the protection layer 20 in close contact with the surface of the insulation coating 12 of the core wire 10 with such a high adhesion force, the protection layer 20 can give a high impact resistance to the core wire 10. Further, by holding each part of the wire materials 21 constituting the protection layer 20 in close contact with the insulation coating 12 with a high adhesion force, the wire materials 21 arranged at respective positions of the core wire 10 are unlikely to be shifted in position in an axial direction A of the core wire 10 and unevenness in the density of the wire materials 21 is unlikely to occur. Further, each wire material 21 is unlikely to be slackened in a radial direction of the core wire 10. As a result, an effect of improving impact resistance by the protection layer 20 can be exhibited with high uniformity along the axial direction A of the core wire 10 and a state where a high impact resistance is exhibited with such high uniformity can be maintained over a long period of time.

The adhesion of the protection layer 20 to the insulation coating 12 with the adhesion force as described above may be achieved by the biting of the strands 21 into the insulation coating 12 described in the first embodiment or may be achieved by another form. For example, form by fusion can be illustrated. If heating is performed with the wire materials 21 constituting the protection layer 20 held in contact with the insulation coating 12 as described above, fusion may occur between the protection layer 20 and the insulation coating 12 by a softened or melted insulating material without being necessarily accompanied by the biting of the wire materials 21 into the insulation coating 12. Strong adhesion can also be achieved by such fusion. Alternatively, a layer of an adhesive may be provided between the insulation coating 12 and the protection layer 20 and strong adhesion may be achieved by bonding via the adhesive. An adhesion force in an interface between the protection layer 20 and the insulation coating 12 may be enhanced by using a plurality of forms of adhesion.

### EXAMPLES

Examples are described below. Note that the present invention is not limited by these Examples. Here, a relationship of the adhesion of a protection layer to an insulation coating of a core wire and impact resistance was evaluated.

[Fabrication of Samples]

Insulated wires each having a protection layer as shown in FIGS. 1A and 1B were fabricated as test samples. Specifically, a conductor having a conductor cross-sectional area of 16 mm² was prepared by twisting aluminum alloy strands. An insulation coating made of cross-linked polyethylene and having a thickness of 1.0 mm was formed on the outer periphery of the conductor to form a core wire. Note that a tensile breaking strength of the cross-linked polyethylene was 15 to 20 MPa and a melting point (before cross-linking) was 150° C.

Wire materials made of Kevlar, which is one type of aramid fibers, are braided into a tube and arranged on the outer periphery of the core wire to form a protection layer made of a braided body. At this time, an inner diameter of a tubular shape of the braided body and an outer diameter of the core wire are set equal except unavoidable deviations, and the wire materials are brought into contact with the surface of the core wire. Note that Kevlar wire materials have a tensile breaking strength of 2800 MPa and has no melting point.

After an assembly of the core wire and the protection layer was heated, this assembly was allowed to cool. Three combinations of a heating temperature and a heating time were set so that an adhesion force of the braided body to the insulation coating was 10 N (sample 1), 80 N (sample 2) and 120 N (sample 3).

Further, a sheath made of the same material as the wire coating and having a thickness of 0.7 mm was formed on the outer periphery of the protection layer to obtain a test sample. In addition to samples 1 to 3 in which the heated protection layer showed the adhesion forces as described above, a sample which was not heated after the protection layer was provided (reference sample 1) was also prepared. Further, a sample in the form of a core wire without having a protection layer and a sheath (reference sample 2) was also prepared.

[Test Methods]

Each of the following tests was conducted at room temperature in the atmosphere for each of the samples obtained above.

(Observation of Surface of Insulation Coating)

For each of samples 1 to 3, the sheath and the protection layer were removed from the surface of the core wire. Then, the surface of the insulation coating of the core wire was visually observed and whether or not a groove-like structure equivalent to depressed parts where the wire materials constituting the protection layer had been biting remained was confirmed. A case where the groove-like structure was observed was determined to be a case where the wire materials were biting, and a case where the groove-like structure was not observed was determined to be a case where the wire materials were not biting.

(Measurement of Adhesion Force)

The adhesion force of the protection layer to the surface of the core wire was measured for each of samples 1 to 3 by the pull-out test. Specifically, each sample was cut to 150 mm and the sheath and the protection layer in a region of 75 mm from an end were peeled to expose the core wire. A through hole having a diameter equivalent to an outer diameter of the core wire was formed in a metal plate, and the exposed core wire was inserted into the through hole. Then, the core wire was pulled at a speed of 50 mm/sec and pulled out from the protection layer. A load required for pull-out was measured by a load cell, and a maximum load was set as the adhesion force of the protection layer to the surface of the core wire. The obtained load was standardized by being divided by 3700 mm², which is a surface area of a region of the core wire covered by the protection layer.

(Measurement of Wire Strength)

Wire strength was measured for samples 1 to 3 and reference samples 1, 2. Specifically, a blade having a thickness of 10 mm was pressed from an outer peripheral part of each sample toward a radial center. While a load applied to the blade was measured by the load cell, the applied load was gradually increased, and a value of the applied load when the insulation coating was broken to expose the conductor was set as the wire strength. As the value of the wire strength thus measured increases, the wire can be assumed to have a higher impact resistance.

[Test Results]

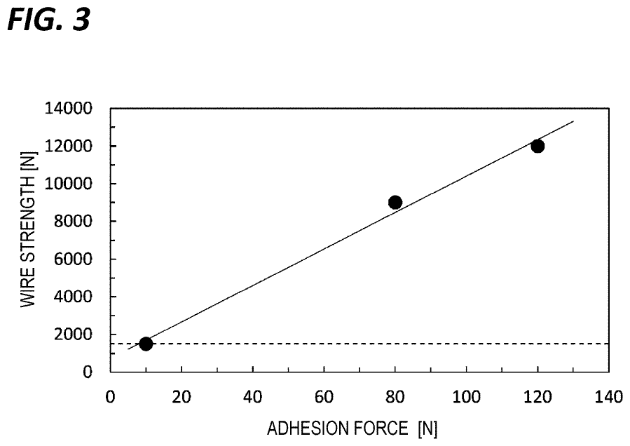

Measurement results obtained for each sample are shown in Table 1 below. Further, FIG. 3 shows a relationship of the adhesion force of the protection layer to the surface of the core wire and the wire strength obtained by measurements. In FIG. 3, measurement values of samples 1 to 3 are shown by plot points and the wire strengths of reference samples 1, 2 are shown by a broken line. Further, an approximate straight line of the plot points of samples 1 to 3 is shown by a solid line. FIG. 4 shows a photographed picture of the surface of the insulation coating of the core wire having the protection layer removed in the above test “Observation of Surface of Insulation Coating” for sample 2. In this picture, stitched parts observed to be brighter than surrounding parts are a groove structure corresponding to the depressed parts where the wire materials of the protection layer were biting.

TABLE 1

| | | | | Reference | Reference |
|---|---|---|---|---|---|
| | | | | Sample 1 | Sample 2 |
| | Sample 1 | Sample 2 | Sample 3 | (not heated) | (only core wire) |
| Biting of Wire Materials | NO | YES | YES | — | — |
| Adhesion Force | | | | | |
| Measured Value [N] | 10 | 80 | 120 | — | — |
| Standardized Value [N/mm²] | 0.003 | 0.022 | 0.032 | — | — |
| Wire Strength [N] | 1500 | 9000 | 12000 | 1500 | 1500 |

According to Table 1 and FIG. 3, it is understood that the wire strength increases as the adhesion force of the protection layer increases. A correlation of the adhesion force and the wire strength can be linearly approximated well. Further, there is no biting of the wire materials into the insulation coating in sample 1 having a small adhesion force of the protection layer, whereas the wire materials are biting in the insulation coating in samples 2 and 3 having a large adhesion force. From these results, it is understood that the wire strength is enhanced and impact resistance is improved by causing the wire materials constituting the protection layer to bite into the insulation coating of the core wire and enhancing the adhesion force of the protection layer to the insulation coating.

Insulated wires used in automotive vehicles can be basically assumed to have a sufficient impact resistance if the wire strength measured as described above is 5000 N or more. According to the approximate straight line for samples 1 to 3, the wire strength of 5000 N corresponds to the adhesion force of the protection layer of 50 N, i.e. 0.014 N/mm². It is understood that a sufficiently high impact resistance can be obtained as a wire for automotive vehicle if the protection layer is in contact with the insulation coating with this adhesion force or more. Note that it is also confirmed that Kevlar constituting the protection layer is thermally deteriorated and any further improvement of the wire strength is difficult even if it is attempted to increase the adhesion force of the protection layer beyond 130 N to increase the wire strength beyond 13000 N.

In reference sample 1 in which the protection layer is arranged on the outer periphery of the core wire and heating was not performed, only the same wire strength as reference sample 2 provided with no protection layer was obtained. That is, the impact resistance of the insulated wire cannot be enhanced only by arranging the protection layer made of the wire materials on the outer periphery of the core wire, and it is necessary for an improvement of impact resistance to cause the wire materials constituting the protection layer to bite into the insulation coating of the core wire and to enhance the adhesion force of the protection layer to the insulation coating. Further, in sample 1 in which the adhesion force of the protection layer is 10 N, the wire strength is not improved as compared to reference samples 1 and 2 and, it can be said that no substantial effect of improving impact resistance is given if the adhesion force of the protection layer is too small that the wire materials do not bite into the insulation coating.

The present invention is not limited to the above embodiments at all, and various changes can be made without departing from the gist of the prevent invention.

1. An insulated wire, comprising:
a core wire including a conductor and an insulation coating made of an insulating material for covering an outer periphery of the conductor; and
a protection layer formed by a wire material having a higher strength than the insulating material constituting the insulation coating and surrounding an outer periphery of the core wire to intersect an axial direction of the core wire,
the wire material constituting the protection layer biting in a surface of the insulation coating.

2. An insulated wire, comprising:
a core wire including a conductor and an insulation coating made of an insulating material for covering an outer periphery of the conductor; and
a protection layer formed by a wire material having a higher strength than the insulating material constituting the insulation coating and surrounding an outer periphery of the core wire to intersect an axial direction of the core wire,
the protection layer being held in close contact with a surface of the insulation coating with an adhesion force of 0.014 N/mm² or more.

3. The insulated wire of claim 1, wherein the protection layer is held in close contact with the surface of the insulation coating with an adhesion force of 0.014 N/mm² or more.

4. The insulated wire of claim 1, wherein the wire materials constituting the protection layer include at least a first group of the wire materials arranged along a first direction intersecting the axial direction of the core wire and a second group of the wire materials arranged along a second direction intersecting the axial direction of the core wire and the first direction.

5. The insulated wire of claim 1, wherein the protection layer is configured as a braided body formed by braiding the wire materials.

6. The insulated wire of claim 1, wherein the wire material constituting the protection layer has a higher melting point than the insulating material constituting the insulation coating.

7. The insulated wire of claim 1, wherein the wire material constituting the protection layer is an organic fiber.

8. The insulated wire of claim 1, wherein the wire material constituting the protection layer is an aramid fiber.

9. The insulated wire of claim 1, wherein the insulating material constituting the insulation coating contains a cross-linked polymer.

10. The insulated wire of claim 1, comprising a sheath made of an insulator for covering an outer periphery of the protection layer.
